(19) United States
(12) Patent Application Publication
(10) Pub. No.: US 2003/0044492 A1
(43) Pub. Date: Mar. 6, 2003

(54) Package and method

(76) Inventors: Wayne I Knigge, Maple Grove, MN (US); Karen E. McClure, Plymouth, MN (US); Patrick J. Sumpmann, Maple Grove, MN (US); William E. Archibald, Maple Grove, MN (US)

Correspondence Address: John A. O'Toole, General Mills, Inc., Number One General Mills Blvd., PO Box 1113, Minneapolis, MN, 55440, US

(21) Appl. No.: 09/945,318

(22) Filed: Aug. 31, 2001

(51) Int. Cl. A23B 4/00

(52) U.S. Cl. 426/124

(57) ABSTRACT

A package is provided, including a bag formed of a material comprising at least one layer, the bag having an exterior portion, an interior portion, an oxygen barrier and a moisture barrier, and being capable of holding a vacuum. Packaged therein is an item comprising a frangible material with a crush resistance or resistance to compression of less than about 7.0PSIA, the item being held in the interior portion of the bag. The interior portion of the bag has less than about 1ppm hexanal therein. A method for packaging the item is also provided.

### FIELD OF THE INVENTION

The present invention is related to packaging of frangible articles, and more particularly to a package and method for packaging frangible products including food products in a vacuum or an environment having less than about 1 ppm hexanal therein.

### BACKGROUND OF THE INVENTION

Many products are vacuum packed. For example, food products such as meat, instant coffee, fruits, cheeses, and dairy products have been vacuum packaged. Vacuum packaging of frangible articles, including foods such as animal feeds, dog foods and cereal-based foods including whole grains has not been accomplished. It has not been possible to vacuum pack such foods without developing rancidity. For example, oat based cereal has a tendency to become rancid in a confined space. Traditionally breathable packages are necessary with oat-based products. A breathable package for example, made of high density polyethylene, allows oxygen to go in and out and get rid of gases which cause rancidity, and do not hold a vacuum.

Further, it has not been possible to package some frangible food items such as popped popcorn, snack chips and cereal flakes without significant breakage and rancidity. There is a need for a package and method which provides a rigid product package which delays or prevents rancidity. Such a package would prevent breakage of the product, and further extend the shelf life of the product contained therein. There is further a need for a package which eliminates the need for corrugated shipping containers and reduces the amount of space the product takes up to ship more product and stock more product. With current fuel prices climbing, such a package would enable more product to be shipped to save on fuel costs.

### SUMMARY OF THE INVENTION

Accordingly, the present invention provides a package comprising a bag formed of a material comprising at least one layer, the bag having an exterior portion, an interior portion, an oxygen barrier and a moisture barrier, and being capable of holding a vacuum. An item comprising a frangible material is held in the interior portion of the bag, the interior portion having less than about 1 ppm hexanal therein. The frangible material has a crush resistance or resistance to compression no less than about 7.0 PSIA. In one embodiment, the frangible material has a resistance to compression of no less than about 14.7 PSI. In one embodiment, the frangible material is cereal based at least a portion thereof comprising a whole grain selected from the group consisting of oats, rice, corn and mixtures thereof. The cereal may include marbits or pieces of marshmallow-based material which may be provided in varied shapes and colors. The frangible material may also be flour, animal feed, dog food or unpopped popcorn.

One of the problems solved by the packages and methods of the present invention is moisture gain prevention, or protection of the food from moisture. Moisture gain is inversely proportional to freshness and serves as measure of freshness. Another problem solved by the present invention is prevention of rancidity. Where there are free fatty acids in a food, such as foods containing whole grains for example, these free fatty acids will reach with any oxygen in the package environment, leading to oxidation, the product of which is a peroxide which reacts to form an aldehyde. An aldehyde formed in such a process is hexanal. Hexanal is a marker for rancidity. At 1 ppm hexanal, rancidity is apparent to the consumer, 1 ppm being the marker for human awareness of rancidity.

In one embodiment, the bag is formed of a film or a single sheet. In one embodiment, the bag comprises a laminate, a co-extrusion, or a combination of the two. The bag comprises a moisture barrier and an oxygen barrier.

In another embodiment, the bag has a semirigid portion, and/or an interior structure and cereal flakes, snack chips or snacks including popped popcorn are packaged therein. Nonlimiting examples of snack chips include fried snacks, potato chips, corn chips, and fried grain based snacks (such as General Mills, Inc.'s “Bugles” corn snacks). In addition to the food packaged therein, the interior portion of the bag is filled with a gas selected from the group consisting of Nitrogen, Nitrous Oxide, Neon, Argon or mixtures thereof oxide to maintain its structure and an interior environment having less than about 1 ppm hexanal.

In one embodiment, the bag has two separate chambers, and the frangible material is cereal based and comprises a nonparticulate portion packaged in the first chamber and a particulate portion packaged in the second chamber.

In a further embodiment, the bag has a perforated portion which when inserted into a cereal carton is located at the top of the carton so the bag is opened by opening the perforated portion thereof. In one embodiment, the bag has a recloseable opening at the top, which may be reclosed by an adhesive, a zipper, a clip or a tin tie.

In one embodiment, the present invention provides a method for vacuum packaging a quantity of a frangible item with a crush resistance or resistance to compression no less than about 14.7 PSI. The method includes providing a bag capable of holding a vacuum, filling the bag with the quantity of frangible material, providing vacuum means, drawing a vacuum on the bag and exhausting the air from the package so the air pressure therein is less than atmospheric pressure, and heat sealing the bag so that the vacuum is maintained therein and the bag has less than about 1 ppm hexanal therein.

In another embodiment, the present invention provides a method for packaging an item comprising a frangible material selected from the group consisting of popped popcorn, snack chips, fried snacks, fried grain based snacks (including but not limited to “Bugles” corn snacks), potato chips, corn chips, cereal flakes and cereal based flakes, which have a resistance to compression lower than 14.7 PSI, but no less than about 7.0 PSIA. The method comprises providing a semirigid bag formed of a material comprising at least one layer, the bag having an exterior portion, an interior portion, an oxygen barrier and a moisture barrier, the semirigid bag further comprising an interior structure and filling the bag with the quantity of frangible material. The air is exhausted from the package while the package is filled with a gas selected from the group consisting of Nitrogen, Nitrous Oxide, Neon, Argon and mixtures thereof, and the bag is heat sealed so that the gas pressure is maintained therein and the bag has less than about 1 ppm hexanal inside.

Alternatively, the frangible material may be a nonfood item such as styrene packing pellets, or foam material, either open cell or a combination of open and closed cell.

The present invention provides a rigid product package through vacuum packing. This package reduces breakage of the cereal, provides the potential of eliminating corrugated shipping cartons, reduces the amount of space the product takes up and enables more product to be packaged, stocked and shipped in the same volume.

### BRIEF DESCRIPTION OF THE FIGURES

FIG. 1 is a top plan view of an embodiment of a vacuum package in accordance with the present invention.

FIG. 2 is a partial section view along line 2-2 of FIG. 1.

FIG. 3 is a top plan view of an embodiment of a package in accordance with the present invention.

FIG. 4 is a top plan view of an embodiment of a package in accordance with the present invention.

FIG. 5 is a top plan view of an embodiment of a package in accordance with the present invention.

FIG. 6 is a top plan view of an embodiment of a package in accordance with the present invention.

FIG. 7 is a top plan view of an embodiment of a package in accordance with the present invention.

FIG. 8 is a top plan view of an embodiment of a package in accordance with the present invention.

FIG. 9 is a top plan view of an embodiment of a package in accordance with the present invention.

FIG. 10 is a top plan view of an embodiment of a package in accordance with the present invention.

FIG. 11 is a top plan view of an embodiment of a package in accordance with the present invention.

FIG. 12 is a perspective view of an embodiment of a package in accordance with the present invention.

FIG. 13 is a schematic perspective view of an embodiment of a package in accordance with the present invention.

FIG. 14 is a schematic top plan view of an embodiment of a package in accordance with the present invention.

FIG. 15 is a schematic top plan view of an embodiment of a package in accordance with the present invention.

FIG. 16 is a schematic top plan view of an embodiment of a package in accordance with the present invention.

FIG. 17 is a schematic top plan view of an embodiment of a package in accordance with the present invention.

FIG. 18 is a schematic top plan view of an embodiment of a package in accordance with the present invention.

FIG. 19 is a schematic top plan view of an embodiment of a package in accordance with the present invention.

FIG. 20 is a schematic top plan view of an embodiment of a package in accordance with the present invention.

FIG. 21 is a schematic top plan view of an embodiment of a package in accordance with the present invention.

FIG. 22 is a schematic perspective view of an embodiment of a package in accordance with the present invention.

FIG. 23 is a perspective view of an embodiment of a package in accordance with the present invention.

FIG. 24 is a perspective view of an embodiment of a package in accordance with the present invention.

FIG. 25 is a perspective view of an embodiment of a package in accordance with the present invention.

FIG. 26 is a perspective view of an embodiment of a package in accordance with the present invention.

FIG. 27 is a top plan view of an embodiment of a package in accordance with the present invention.

FIG. 28 is a perspective view of an embodiment of a package in accordance with the present invention.

FIG. 29 is a top plan view of an embodiment of a package in accordance with the present invention.

FIG. 30 is a perspective view of an embodiment of a package in accordance with the present invention.

FIGS. 31A-C are schematic perspective views of cereal packaged in accordance with the present invention.

FIGS. 31D-E are schematic top plan views of cereal packaged in accordance with the present invention.

FIGS. 31F-H are schematic perspective views of cereal packaged in accordance with the present invention.

FIG. 31I is a schematic side view of cereal packaged in accordance with the present invention.

FIG. 31J is a schematic perspective view of cereal packaged in accordance with the present invention.

### DETAILED DESCRIPTION

In the following detailed description of the preferred embodiments, reference is made to the accompanying drawings which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical or chemical changes may be made without departing from the spirit and scope of the present invention. The following detailed description is, therefore, not to be taken in a limiting sense, and the scope of the present invention is defined only by the claims.

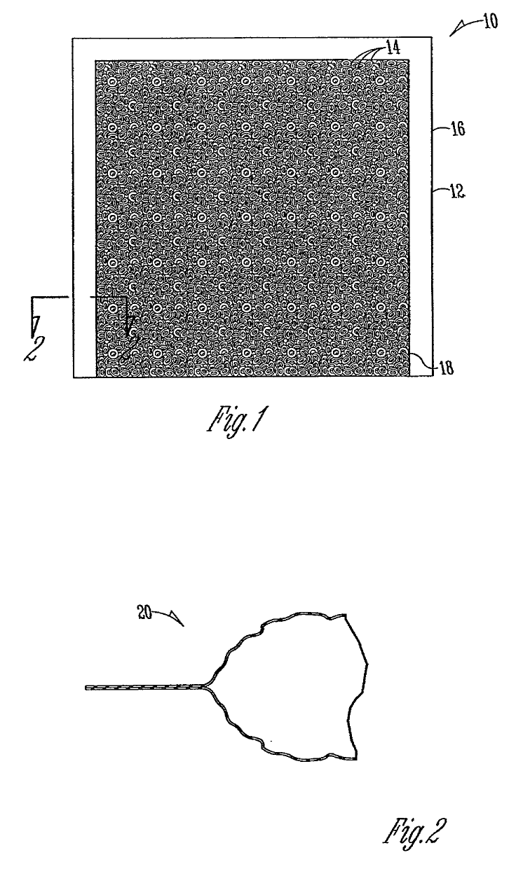

Referring now to FIG. 1, the present invention provides a package 10 which comprises a bag 12 and an item 14 packaged therein. In one embodiment, the bag 12 has an exterior portion 16, an interior portion 18, an oxygen barrier and a moisture barrier, and is capable of holding a vacuum. In one embodiment, an item 14 (as shown at FIG. 1) comprising a frangible material with a crush resistance or resistance to compression no less than about 7.0 PSIA is held in the interior portion 18 of the bag 12. The interior portion 18 of the bag 12 has less than about 1 ppm hexanal therein.

The bag 12 is formed from a material having at least one layer. The bag 12 may be formed of a film, or from a single sheet. In one embodiment, as shown in FIG. 1-2, the bag is made of a laminate 20. The laminate has an oxygen permeability of no greater than about 0.02 cc/100 in.² in about one day. In a further embodiment, the laminate has an oxygen permeability of no greater than about 0.013 cc/100 in.² in about one day. The laminate may be a flexible material comprising a polymer substrate selected from the group consisting of polyethylene (PE), polypropylene (PP), polyethylene terephthalate (PET), and polylactic acid (PLA), an oxygen barrier layer, and a moisture barrier layer comprising a metallized polymeric composite. The laminate may further comprise a film or ceramic including a component selected from the group consisting of oxygen scavengers and antioxidants. In one embodiment, oxygen scavengers are incorporated into the substrate, the oxygen scavengers being selected from the group consisting of light activated oxygen scavengers and conventional oxygen scavengers. In one embodiment, the laminate is a flexible material comprising a layer of aluminum oxide coated polyethylene, a layer of polyester, a layer of glass or ceramic, and a polyester sealant interior of the aluminum oxide coated polyethylene layer. In a further embodiment, the laminate comprises a moisture barrier coating exterior of an oxygen barrier coating.

In one embodiment, the bag comprises a co-extrusion of at least two materials. In a further embodiment, the bag is a combination of a laminate and a coextrusion.

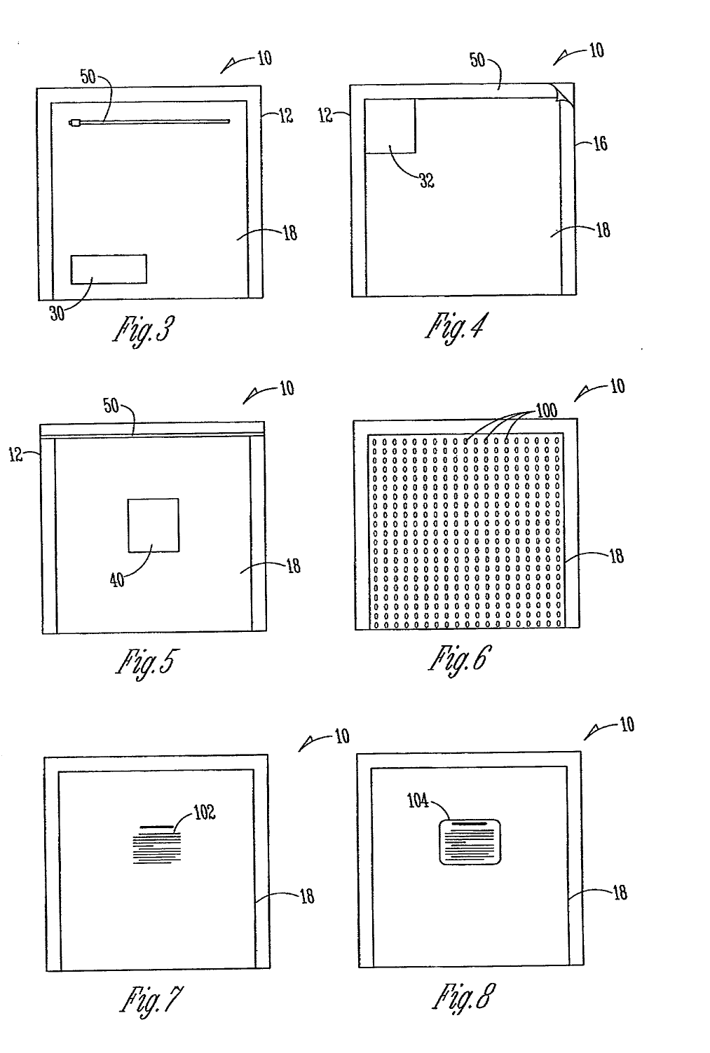

In one embodiment, the bag includes a coupon or premium 30 which may be located on the exterior portion of the bag (as shown at FIG. 3), or alternatively may be provided within the bag 12. Alternatively the bag 12 may include a compartment 32 in which the coupon is located (as shown at FIG. 4).

By way of example, the bag may be clear, translucent or opaque. An opaque bag may further comprise a transparent window 40 (as shown at FIG. 5) to view the product. The exterior portion of the bag may be textured, as shown at FIG. 6. For example, bag 12 may have dimples 100. Referring to FIGS. 7 and 8, the bag may be preprinted with product information 102, or may further comprise a pressure sensitive label 104 affixed to the exterior portion of the bag, the label providing product information.

The item to be packaged may be a non-food item such as styrene pellets, open cell foam items, closed cell foam items, or items with both open and closed cell foam components.

The item to be packaged may be a frangible material including food items such as cereals, cereal based materials, unpopped popcorn, animal feeds and dog foods. A cereal packaged according to the present invention may include marbits or pieces of marshmallow-based material which may be provided in varied shapes and colors (hearts, moons, stars, clovers, etc.). In general, the frangible material has a crush resistance of between about 7.0 PSIA-100 PSIA.

In one embodiment, the frangible material is a cereal based material at least a portion of which comprises a whole grain selected from the group consisting of whole grain oats, whole grain rice, whole grain corn and mixtures thereof. The cereal-based material may further comprise soybean flour. In one embodiment, the frangible material has a crush resistance of about 14.7 PSIA. Referring to FIG. 31, the cereal-based material may be provided in the form of biscuits (31a), pillows (31b), shreds (31c), or puffed pieces (31d-g). The puffed pieces may be oat, corn, rice or mixtures thereof. The puffed pieces may be ring shaped (31d), square (31e), spherical (31f) or convex (31g). Alternatively, the puffed pieces may have an irregular shape, i.e. a random shape (31h) or pattern such as a figure, a vehicle (31i) or animal (31j), for example.

In one embodiment, a package according to the present invention comprises a bag formed of a flexible material comprising a laminate having an oxygen barrier and a moisture barrier, the package being capable of holding a vacuum, and a ready to eat (RTE) cereal having a crush resistance of no less than about 14.7 PSIA. The cereal may be any suitable cereal which possesses the strength characteristics to withstand a vacuum, such as any expanded whole grain cereal.

It is known that whole grains such as oats, and oat flour have a tendency to become rancid. It has not been possible to vacuum package whole grain cereals without developing rancidity. Whole grain based cereals such as oat-based cereal, for example, have a tendency to become rancid in a confined space. Free fatty acids present in the whole grain flour or oat flour react with the oxygen molecules and cause rancidity. The germ of any whole grain contains unsaturated fat which reacts with oxygen molecules to cause rancidity. Rancidity is commonly measured by the amount of hexanal present, the measure of rancidity which is detectable by humans is about 1 ppm hexanal.

Traditionally breathable packages with no oxygen barrier are necessary with oat-based products, and other products with whole grain components. For example, vertical form filled and sealed (VFFS) packages made of high density polyethylene breathe to allow the oxygen to go in and out and get rid of gases which cause rancidity. These packages, however, do not hold a vacuum. It has been found that olefins, paraffms, ethylene and polyethylene provide a good moisture barrier, but are poor oxygen barriers.

In one embodiment, the cereal packaged according to the present invention is an expanded oat based cereal made of conditioned oat flour as described in U.S. Pat. No. 5,523,109, incorporated herein by reference. The oat flour described in U.S. Pat. No. 5,534,109 is pretreated to reduce or prevent rancidity. It has unexpectedly been found that the combination of the flexible laminated package having an oxygen barrier and a moisture barrier with the expanded oat based cereal made of an oat flour vacuum packaged therein produces the unexpected result of virtually eliminating rancidity, and nearly doubling the shelf life of the packaged cereal. The oat flour described in U.S. Pat. No. 5,523,109 is an example of such an oat flour. A grain based extruded product as described in U.S. Pat. No. 6,010,732, incorporated herein by reference, is another example of a product that is suitable for packaging according to the present invention.

The cereal provided may be any suitable cereal possessing the strength characteristics to withstand a vacuum. The expanded RTE cereal may be made of an oat flour which has a tendency to become rancid and is pretreated to reduce or prevent rancidity. For example, the oat flour may be preconditioned oat flour having minimal peroxidase activity and a ratio of the HPLC syringic acid peak to ferulic acid peak no less than about 2.5.

In one embodiment of the present invention, the package is vacuum-sealed. In one embodiment, the package further comprises a closure seal 50, which in one embodiment is resealable. The closure seal may be strong enough to maintain the vacuum conditions within the package.

Vacuum packing cereal confines expanded cereals to the point were the cereal has the inherent strength to provide the necessary strength to store and ship the cereals. plus prevent moisture from reducing shelf life. Vacuum packing provides the strength to ship cereals without the need of cartons or shipping cases.

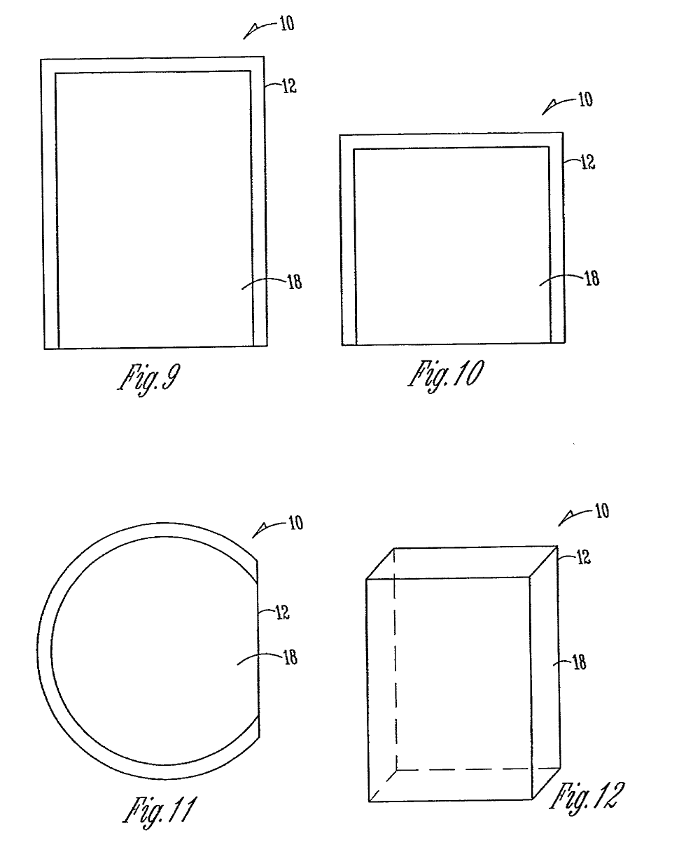

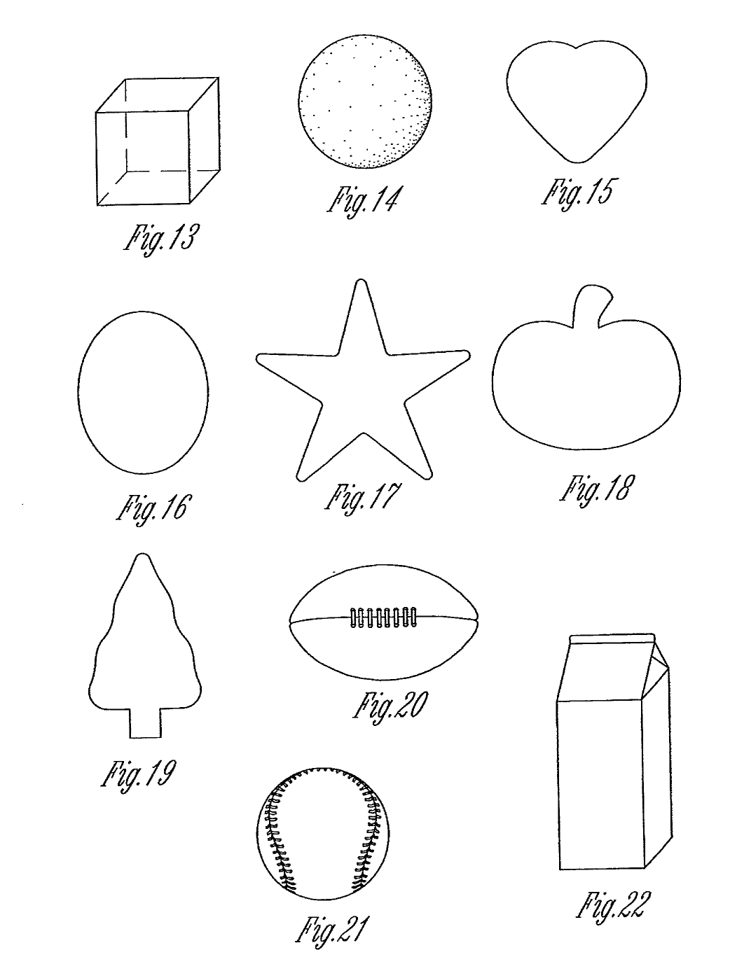

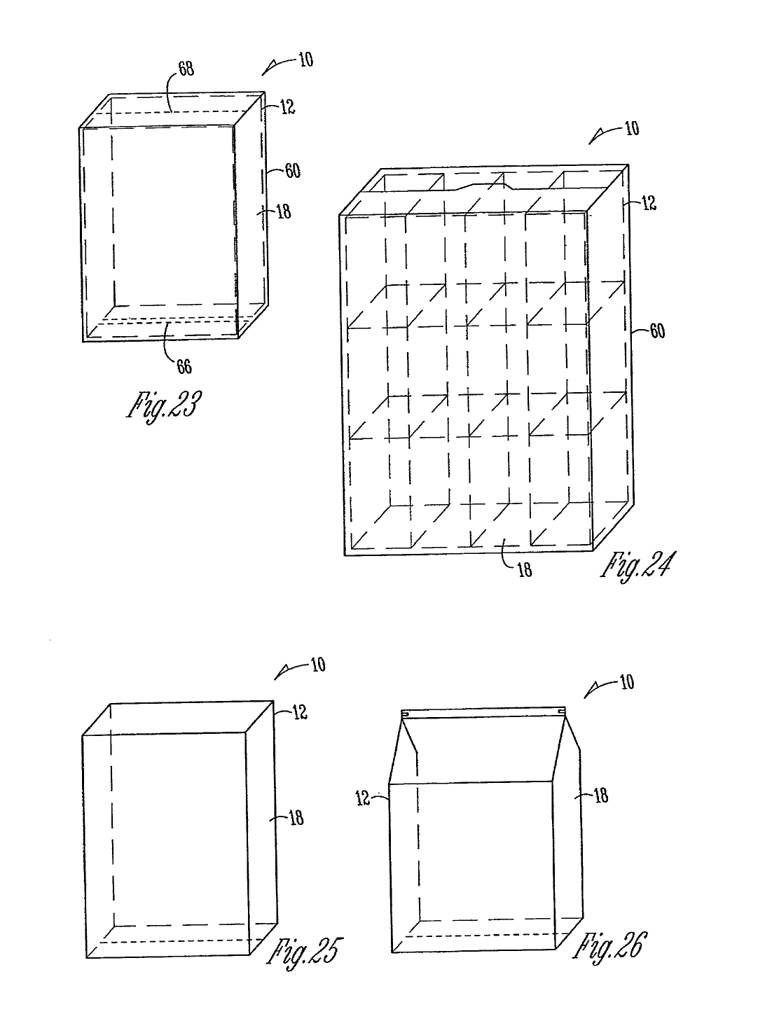

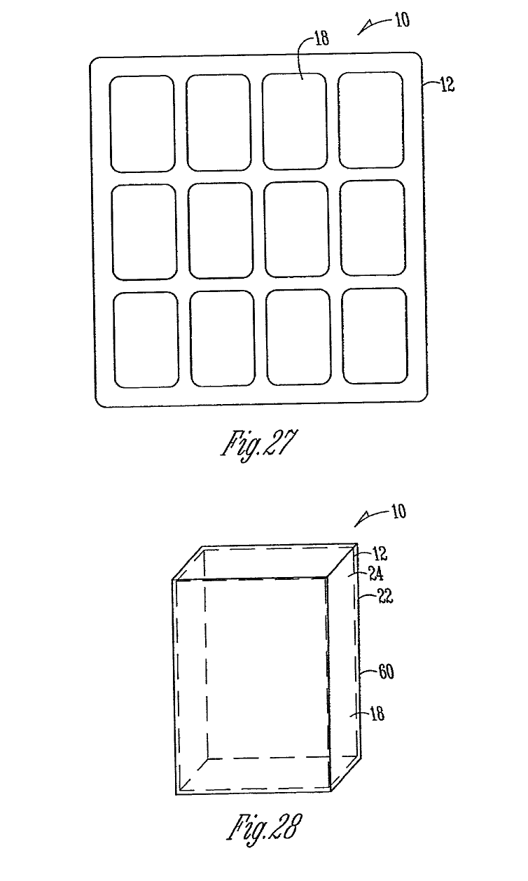

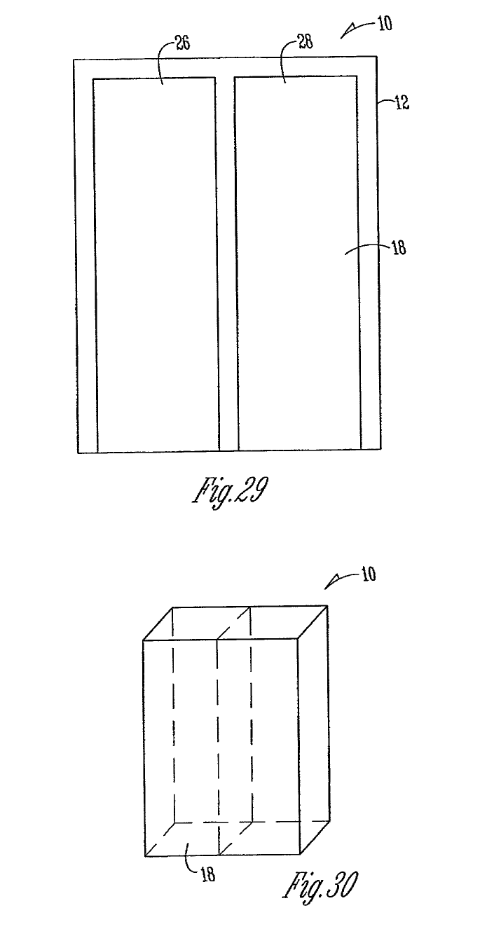

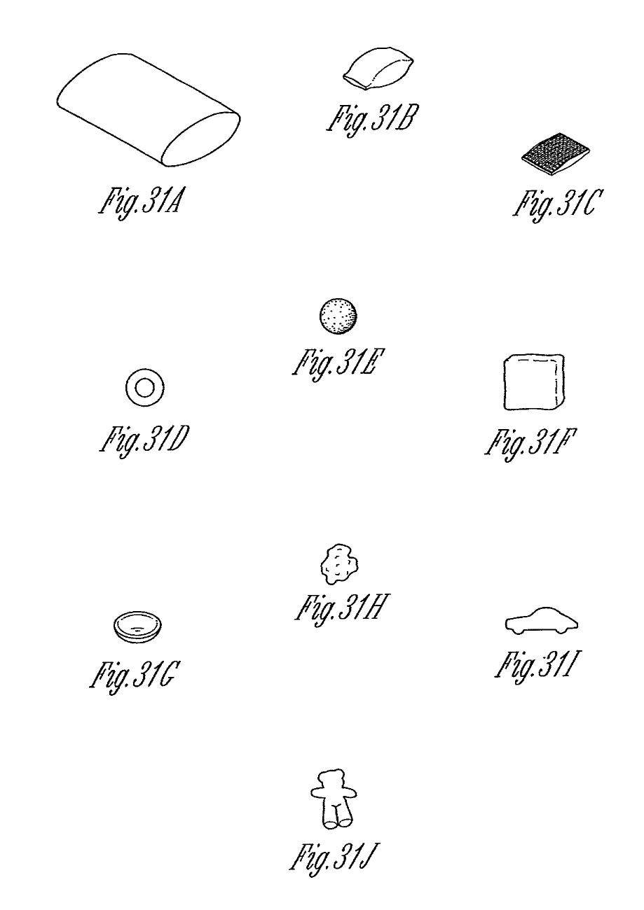

In one embodiment, the package is preformed and has a predetermined shape. For example, referring to FIGS. 9-22, the package may have a preformed shape such as a rectangular shape (FIG. 9), a square shape (FIG. 10), a circular shape (FIG. 11), a rectangular cube shape (FIG. 12), a square cube shape (FIG. 13), a spherical shape (FIG. 14), a heart shape (FIG. 15), an egg shape (FIG. 16), a star shape (FIG. 17), a pumpkin shape (FIG. 18), a Christmas tree shape (FIG. 19), a football shape (FIG. 20), a basketball or baseball shape (FIG. 21) or a milk carton shape (FIG. 22).

In the embodiments shown at FIGS. 23 and 24, the packaged cereal further comprises a cereal carton 60. The cereal carton may be made of any suitable material. For example, the cereal carton may be made of paperboard. The cereal carton has a bottom 62 and a top 64. Referring to FIG. 23, the top of the bag 12 has a vacuum seal 66 and the bottom of the bag is flat or planar and has a pre-perforated portion 68 which may also be pre-printed. The bag 12 is inserted in the carton so that the bottom of the bag 12 is at the top of the carton 60. The bag 12 is opened by opening the perforated portion 68. In one embodiment, the bottom of the package further comprises a closure means such as a plastic zipper to reclose the package after it is opened by opening the perforated portion. The package may also be reclosed with tin ties or tape which would be affixed to the package.

In one embodiment, as shown at FIGS. 3-5 and 26, the package comprises a rectangular bag having a bottom, a pair of opposed sides and a top, the bag further comprising a recloseable opening at the top. The recloseable opening may comprise an adhesive seal, shown at FIG. 4, a tacky pressure sensitive adhesive, a zipper (as shown at FIG. 3) or a clip (as shown at FIG. 26).

The package may be formed of a laminate. The laminate is a plastic film that has oxygen barrier properties to it so it will prevent oxygen from migrating into the product and will thus hold a vacuum. In one embodiment, the laminate has an oxygen permeability of no greater than about 0.02 cc/100 in.². In a further embodiment, the laminate has an oxygen permeability of no greater than about 0.05 cc/100 in.² in about one day. In one embodiment, the laminate has an oxygen permeability of no greater than about 0.013 cc/100 in.² in about one day.

The laminate also has a moisture barrier. Freshness of a product is defined by an absence or minimizing moisture gain. As a cereal gains moisture, the cereal is going bad. The barrier film virtually prevents moisture gain.

In one embodiment, the flexible laminate material comprises a polymer substrate, an oxygen barrier layer and a moisture barrier comprising a metallized polymeric composite. The polymer substrate is selected from the group consisting of polyethylene (PE), polypropylene (PP), polyethylene terephthalate (PET), and polylactic acid (PLA). In one embodiment the moisture barrier layer is a coating exterior of an oxygen barrier coating. An example of a suitable material is set forth in U.S. Pat. No. 5,487,940, incorporated herein by reference.

The package may further include a film or ceramic including a component selected from the group consisting of oxygen scavengers and antioxidants, such as are disclosed in U.S. Pat. No. 5,977,212, incorporated herein by reference.

In one embodiment, the flexible laminate material comprises a layer of aluminum oxide coated polyethylene, and further comprises a layer of polyester, a layer of glass or ceramic and a polyester sealant interior of the aluminum oxide coated polyethylene layer.

In one embodiment of the present invention, a method for vacuum packaging a quantity of an item is provided. The item is a frangible material with a crush resistance or resistance to compression no less than about 7.0 PSI. A bag capable of holding a vacuum is provided, and the bag is filled with the quantity of frangible material. A vacuum means is provided. For example, a vacuum tube and nozzle may be removably coupled to the bag. A vacuum is drawn on the bag, viding a vacuum means. A vacuum is drawn on the bag and the air is exhausted from the bag so that the air pressure therein is less than atmospheric pressure. Applicant has found that a 2 vacuum environment or 500 millibar does not work. However, an environment at 11 millibar is a sufficient vacuum according to the present invention. Alternatively, the bag is flushed with a gas selected from the group consisting of Nitrogen, Nitrous Oxide, Argon, Neon or mixtures thereof, after which a pressure of 150 millibar in the gas environment is adequate for the package. For less crush resistant materials, the oxygen is removed and replaced with a gas such as Ne, Ar, Nitrogen or Nitrous Oxide at a pressure of 7.0 PSIA. The bag is heat sealed so that the vacuum is maintained therein, and the bag has less than about 1 ppm hexanal therein.

For less crush resistant materials, the oxygen is removed and replaced with carbon dioxide or another inert gas such as Neon, Argon, The sealed vacuum package may be placed in a shipping carton. Alternatively, the sealed vacuum package may be placed in a cereal carton prior to placement in a shipping carton. The vacuum may be temporary, and release after the package is placed in the cereal carton.

In one embodiment the method comprises providing a bag and filling it with cereal. The bag is then inserted into a tooling sized to fit inside a specific carton. In a vacuum chamber, a vacuum is pulled on the package. The bag is then sealed while still in the vacuum chamber. Optionally, the package is placed in a paperboard cereal carton. The package may optionally then be placed in a shipping carton.

In an alternative embodiment, the method comprises providing a bag of flexible laminate material having an oxygen barrier and a moisture barrier, and being capable of holding a vacuum. The bag is filled with a predetermined quantity of frangible material, for example, RTE cereal.

Where the bag is a flat bag, prior to filling the container, the method includes placing the bag on a mandrel, placing the mandrel and bag inside a chamber to establish and maintain a rectangular shape like that of a cereal box and withdrawing the mandrel so the bag can be filled. In a further embodiment, after the bag is filled, for example, with a quantity of RTE cereal, pressure is applied to the cereal within the container to compact the cereal. The pressure may be applied from below or above the bag, and may be applied by gravity or springs. The package is then flushed with a gas selected from the group consisting of Nitrogen, Nitrous Oxide, Neon, Argon and mixtures thereof.

In one embodiment, the vacuum packaging process may be used to package individual serve portions of cereal. The individual portions may then be packaged into a carton, as shown at FIG. 24. The individual servings may be packaged in individual serving bags. Alternatively, the cereal may be placed in one bag, as shown at FIG. 27, which is inserted into a tooling sized to fit a predetermined number of individual servings into a particular carton. A vacuum is pulled on the bag and it is sealed as described hereinabove. Instead of ten 1 oz. servings, the carton could contain ten 1.3 oz. servings packaged according to the method.

A process utilized in the coffee industry as is disclosed in U.S. Pat. No. 5,352,466, incorporated herein by reference, may also be modified to package cereal according to the present invention.

In one embodiment, the item to be packaged is a food product selected from the group consisting of popped popcorn, popped popcorn based snacks, snack chips, fried snacks, potato chips, corn chips, fried grain based snacks (such as General Mill's, Inc.'s “Bugles” corn snacks, corn puffs, corn tortilla chips and the like), cereal flakes, and cereal based flakes. The item may comprise flakes of a cereal-based material including a whole grain selected from the group consisting of whole grain oats, whole grain rice, whole grain corn and mixtures thereof. The cereal-based material may further comprise soybean flour.

The crush resistance of such items is generally lower than 14.7 PSI. The bag for packaging such an item, as shown at FIG. 28, has a semirigid portion 22, and may further comprise an interior structure 24.

In one embodiment, the packaging method comprises providing a quantity of a frangible material selected from the group consisting of popped popcorn, snack chips, cereal flakes and cereal-based flakes. A semirigid bag is provided, the bag being formed of a material comprising at least one layer, the bag having an exterior portion, an interior portion, an oxygen barrier and a moisture barrier, and being capable of holding a vacuum. The semirigid bag further comprises an interior structure. The bag is filled with the quantity of frangible material. The air is then exhausted from the package while filling the package with a gas selected from the group consisting of Nitrogen, Nitrous Oxide, Neon and Argon, and the bag is heat sealed so that the gas pressure is maintained therein and the bag has less than about 1 ppm hexanal therein.

In one embodiment, the item to be packaged is a food product which is cereal based and comprises a nonparticulate portion and a particulate portion. Referring to FIGS. 29-30, the bag 12, comprises a first chamber 26, in which the nonparticulate portion is packaged, and a second chamber 28 separated from the first chamber, in which the particulate portion is packaged. The nonparticulate portion and particulate portion have a ΔA_{w} of at least about 0.1. The particulate portion has an A_{w} of about 0.2-0.4, and the nonparticulate portion has an A_{w} of no greater than about 0.7. In a one embodiment, the nonparticulate portion comprises raisins which have an A_{w} of about 0.6. The components have a different water activity, and separation of them prevents mold.

Advantages of the present package and method include increased manufacturing efficiency, the ability to package more product per cubic foot, lower transportation costs, reduced packaging materials per ounce of product, increased package strength, improved freshness, and increased shelf life.

Vacuum packaging according to the present method will enable placement of more product in the same size cereal carton. Vacuum packaging of cereal will allow a package to be filled with approximately 20-60% more product. The individual packages may be filled with about 20-30% more product, where the large cereal packages may be filled with about 50-60% more product. A greater volume of product can be sold in the same carton. For example, 22 ounces of cereal may be packaged in a carton which currently holds 15 ounces of cereal.

The vacuum package according to the present invention also increases the ease of insertion of the cereal bag into a carton, the bag being easier to place in a carton than a standard VFFS bag currently used in the industry. Even if the vacuum is temporary, release of the vacuum and allowing the bag to return to atmospheric pressure will not reverse the compression. The product will remain tightly packaged in the carton.

According to the present package and method, less packaging materials are used per ounce of product. This results in reduced distribution costs and packaging materials costs. The strength of the packages may reduce or eliminate the need for corrugated shipping cases, leading to further reduction in packaging and distribution costs.

Vacuum packaging according to the method disclosed herein will enhance and preserve freshness of the cereal packaged therein, and will extend its shelf life.

### Conclusion

The present invention provides a method and package for vacuum packaging a quantity of a frangible item with a crush resistance or resistance to compression no less than about 7.0 PSIA. The method includes providing a bag capable of holding a vacuum, filling the bag with the quantity of frangible material, providing vacuum means, drawing a vacuum on the bag and exhausting the air from the package so the air pressure therein is less than atmospheric pressure, and heat sealing the bag so that the vacuum is maintained therein and the bag has less than about 1 ppm hexanal therein. The bag is formed of a material comprising at least one layer, the bag having an exterior portion, an interior portion, an oxygen barrier and a moisture barrier. In one embodiment, the bag is formed of a film or a single sheet. In one embodiment, the bag comprises a laminate, a co-extrusion, or a combination of the two. In a further embodiment, the bag has two separate chambers, and the frangible material is cereal based and comprises a nonparticulate portion packaged in the first chamber and a particulate portion packaged in the second chamber. In a still further embodiment, the bag has a perforated portion which when inserted into a carton is located at the top of the carton so the bag is opened by opening the perforated portion thereof. In one embodiment, the bag has a recloseable opening at the top, which may be reclosed by an adhesive, a zipper, a clip or a tin tie. In one embodiment, the frangible material is cereal based, at least a portion thereof comprising a whole grain selected from the group consisting of oats, rice, corn and mixtures thereof. The cereal may include marbits or pieces of marshmallow-based material which may be provided in varied shapes and colors. The frangible material may also be flour, animal feed, dog food or unpopped popcorn. Alternatively, the frangible material may be a nonfood item such as styrene packing pellets, or foam material, either open cell or a combination of open and closed cell.

In addition, a package and method is provided for packaging an item comprising a frangible material having a resistance to compression less than about 7.0 PSIA, selected from the group consisting of popped popcorn, popcorn based snacks, snack chips (nonlimiting examples of which include fried snacks, potato chips, corn chips, fried or baked grain based snacks), cereal flakes and cereal based flakes. The method comprises providing a semirigid bag comprising an interior structure and filling the bag with the quantity of frangible material. The air is exhausted from the package while the package is filled with a gas selected from the group consisting of Nitrogen, Nitrous Oxide, Argon, Neon and mixtures thereof, and the bag is heat sealed so that the gas pressure is maintained therein and the bag has less than about 1 ppm hexanal inside.

A rigid package is provided which reduces breakage of the item packaged therein, if applicable enhances freshness and increases shelf life, and further enables a greater amount of product per volume to be packaged, stocked and shipped.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. A package comprising:
a bag formed of a material comprising at least one layer, the bag having an exterior portion, an interior portion, an oxygen barrier and a moisture barrier, and being capable of holding a vacuum; and
an item comprising a frangible material with a crush resistance or resistance to compression no less than about 7.0 PSIA, the item being held in the interior portion of the bag, the interior portion of the bag having less than about 1 ppm hexanal therein.

2. The package of claim 1 wherein the bag is formed of a film.

3. The package of claim 1 wherein the bag is formed from a single sheet.

4. The package of claim 1 further comprising an exterior carton in which the package is enclosed.

5. The package of claim 1 wherein the bag further comprises a coupon or premium.

6. The package of claim 5 wherein the coupon or premium is located on the exterior portion of the bag.

7. The package of claim 5 wherein the coupon or premium is located in the interior portion of the bag.

8. The package of claim 5 further comprising a separate compartment in which the coupon is located.

9. The package of claim 1 wherein the bag is translucent.

10. The package of claim 1 wherein the bag is opaque.

11. The package of claim 10 wherein the bag further comprises a transparent window.

12. The package of claim 1 wherein the exterior portion of the bag is textured.

13. The package of claim 1 wherein the bag is preprinted with product information.

14. The package of claim 1 wherein the bag further comprises a pressure sensitive label affixed to the exterior portion of the bag.

15. The package of claim 1 wherein the frangible material has a crush resistance of between about 14.7 PSIA-100 PSIA.

16. The package of claim 1 wherein the frangible material is a cereal based material at least a portion of which comprises a whole grain selected from the group consisting of whole grain oats, whole grain rice, whole grain corn and mixtures thereof

17. The package of claim 16 wherein the cereal based material further comprises soybean flour.

18. The package of claim 16 wherein the cereal based material is in the form of biscuits.

19. The package of claim 16 wherein the cereal based material is in the form of shreds.

20. The package of claim 16 wherein the frangible material is in the form of puffed pieces.

21. The package of claim 20 wherein the puffed pieces are ring shaped, spherical or convex.

22. The package of claim 20 wherein the puffed pieces have an irregular shape.

23. The package of claim 16 wherein the cereal based material is in the form of pillows.

24. The package of claim 16 wherein the frangible material further comprises marbits.

25. The package of claim 1 wherein the frangible material is unpopped popcorn.

26. The package of claim 1 wherein the frangible material comprises styrene pellets.

27. The package of claim 1 wherein the bag has a semirigid portion.

28. The package of claim 27 further comprising an interior structure.

29. The package of claim 27 wherein the frangible material is selected from the group consisting of popped popcorn and snack chips.

30. The package of claim 27 wherein the frangible material comprises flakes of a cereal based material including a whole grain selected from the group consisting of whole grain oats, whole grain rice, whole grain corn and mixtures thereof.

31. The package of claim 30 wherein the cereal based material further comprises soybean flour.

32. The package of claim 27 wherein the bag is filled a gas selected from the group consisting of Nitrogen, Nitrous Oxide, Argon, Neon and mixtures thereof.

33. The package of claim 1 wherein the bag has a first chamber and second chamber separated from the first chamber.

34. The package of claim 33 wherein the frangible material is cereal based and comprises a nonparticulate portion packaged in the first chamber and a particulate portion packaged in the second chamber.

35. The package of claim 34 wherein the nonparticulate portion and particulate portion have a ΔA_{w} of at least about 0.1.

36. The package of claim 34 wherein the particulate portion has an A_{w} of about 0.2-0.4.

37. The package of claim 34 wherein the nonparticulate portion has an A_{w} of no greater than about 0.7.

38. The package of claim 37 wherein the nonparticulate portion has an A_{w} of about 0.6.

39. The package of claim 1 wherein the frangible material comprises a cereal made of an oat flour which has a tendency to become rancid and is pretreated to reduce or prevent rancidity.

40. The package of claim 1 wherein the bag is vacuum-sealed.

41. The package of claim 1 wherein the bag further comprises a closure.

42. The package of claim 41 wherein the bag is recloseable.

43. The package of claim 1 wherein the bag is preformed and has a predetermined shape, and the frangible material is a cereal based material having a crush resistance of at least about 7.0 PSIA, at least a portion of the material comprising a whole grain.

44. The package of claim 43 herein the bag is vacuum-sealed.

45. The package of claim 44 comprising a seal strong enough to maintain said vacuum conditions within the package.

46. The package of claim 43 wherein the predetermined shape is selected from the group consisting of a rectangular shape, a brick shape, a square shape, a circular shape, a rectangular cube shape, a square cube shape, a spherical shape, a heart shape, an egg shape, a star shape, a pumpkin shape, a Christmas tree shape, a football shape, a basketball shape and a milk carton shape.

47. The package of claim 46 wherein the bag is preformed in the shape of a rectangular cube.

48. The package of claim 43 further comprising a cereal carton in which the bag is enclosed.

49. The package of claim 48 wherein:
the cereal carton has a bottom and a top;
the bag has a bottom and a top;
the top of the bag has a vacuum seal and the bottom of the bag has a perforated portion; and
the bag is inserted in the carton so that the bottom of the bag is at the top of the carton and the bag is opened by opening the perforated portion thereof.

50. The package according to claim 49 wherein the cereal carton is made of paperboard.

51. The package of claim 43 wherein the bag is rectangular and comprises a bottom, a pair of opposed sides, a top, and a recloseable opening at the top.

52. The package of claim 51 wherein the recloseable opening further comprises an adhesive closure.

53. The package of claim 52 wherein the adhesive closure comprises a tacky pressure sensitive adhesive.

54. The package of claim 51 wherein the recloseable opening further comprises a cold seal.

55. The package of claim 51 wherein the recloseable opening further comprises a zipper.

56. The package of claim 51 wherein the recloseable opening further comprises a clip mechanism.

57. The package of claim 51 wherein the recloseable opening further comprises a tin tie.

58. The package of claim 1 wherein the bag is made of a laminate.

59. The package of claim 58 wherein the laminate has an oxygen permeability of no greater than about 0.02 cc/100 in.² in about one day.

60. The package of claim 58 wherein the laminate has an oxygen permeability of no greater than about 0.05 cc/100 in.² in about one day.

61. The package of claim 58 wherein the laminate has an oxygen permeability of no greater than about 0.013 cc/100 in.² in about one day.

62. The package of claim 58 wherein the laminate is a flexible material comprising:
a polymer substrate selected from the group consisting of polyethylene (PE), polypropylene (PP), polyethylene terephthalate (PET), and polylactic acid (PLA);
an oxygen barrier layer; and
a moisture barrier layer comprising a metallized polymeric composite.

63. The package of claim 62 further comprising a film or ceramic including a component selected from the group consisting of oxygen scavengers and antioxidants.

64. The package of claim 58 wherein the laminate is a flexible material comprising:
a layer of aluminum oxide coated polyethylene;
a layer of polyester;
a layer of glass or ceramic; and
a polyester sealant interior of the aluminum oxide coated polyethylene layer.

65. The package of claim 58 wherein the laminate comprises a moisture barrier coating exterior of an oxygen barrier coating.

66. The package of claim 58 wherein the bag further comprises a co-extrusion of at least two materials.

67. The package of claim 1 wherein the bag comprises a co-extrusion of at least two materials.

68. A method for vacuum packaging an item, the method comprising:
providing a quantity of an item to be packaged comprising a frangible material with a crush resistance or resistance to compression no less than about 7.0 PSIA;
providing a bag capable of holding a vacuum;
filling the bag with the quantity of frangible material;
providing vacuum means, drawing a vacuum on the bag and exhausting the air from the package so the air pressure therein is less than atmospheric pressure; and
heat sealing the bag so that the vacuum is maintained therein and the bag has less than about 1 ppm hexanal therein.

69. The method of claim 68 wherein prior to filling the bag the method further comprises:
placing the bag on a mandrel;
placing the mandrel and bag inside a chamber to establish and maintain a rectangular shape like that of a cereal box; and
withdrawing the mandrel.

70. The method of claim 68 wherein the vacuum means comprises a vacuum tube and nozzle removably coupled to the package.

71. The method of claim 68 further comprising placing the sealed vacuum package in a shipping carton.

72. The method of claim 68 wherein the frangible material comprises a cereal based material and the method further comprises placing the sealed vacuum package in a cereal carton prior to placement in a shipping carton.

73. The method of claim 68 further comprising applying pressure to the frangible material within the bag to compact the frangible material before providing a vacuum means and drawing a vacuum on the package.

74. The method of claim 73 further comprising flushing the package with a gas selected from the group consisting of Nitrogen, Nitrous Oxide, Argon, Neon and mixtures thereof, after applying pressure to the cereal and before providing a vacuum means and drawing a vacuum on the package.

75. The method of claim 68 wherein the vacuum is temporary, and releases after the package is placed in the cereal carton.

76. A method for packaging an item, the method comprising:
providing a quantity of an item to be packaged comprising a frangible material selected from the group consisting of popped popcorn, snack chips, cereal flakes and cereal based flakes;
providing a semirigid bag formed of a material comprising at least one layer, the bag having an exterior portion, an interior portion, an oxygen barrier and a moisture barrier, and being capable of holding a vacuum, the semirigid bag further comprising an interior structure;
filling the bag with the quantity of frangible material;
exhausting the air from the package while filling the package with a gas selected from the group consisting of Nitrogen, Nitrous Oxide, Argon, Neon and mixtures thereof; and
heat sealing the bag so that the gas pressure is maintained therein and the bag has less than about 1 ppm hexanal therein.
